(19) United States
(12) Patent Application Publication
(10) Pub. No.: US 2014/0049454 A1
(43) Pub. Date: Feb. 20, 2014

(54) Pixel and Organic Light Emitting Display Using the Same

(71) Applicant: SAMSUNG DISPLAY CO., LTD., Yongin City (KR)

(72) Inventor: Ji-Hyun Ka, Yongin-City (KR)

(73) Assignee: SAMSUNG DISPLAY CO., LTD., Yongin-City (KR)

(21) Appl. No.: 13/680,988

(22) Filed: Nov. 19, 2012

(30) Foreign Application Priority Data
Aug. 20, 2012 (KR) 10-2012-0090752

(51) Int. Cl. G09G 3/32

(52) U.S. Cl. CPC G09G 3/3208
USPC 345/76

(57) ABSTRACT

A pixel capable of increasing a contrast ratio includes an organic light emitting diode (OLED), a first transistor for controlling an amount of current supplied from a first node coupled to a first electrode thereof to the OLED coupled to a second electrode thereof so as to correspond to a voltage applied to a second node, a second transistor coupled between the second electrode of the first transistor and the OLED and turned off when an emission control signal is supplied to an emission control line, and a capacitor coupled between the second electrode of the first transistor and the emission control line.

### CLAIM OF PRIORITY

This application makes reference to, incorporates the same herein, and claims all benefits accruing under 35 U.S.C. §119 from an application earlier filed in the Korean Intellectual Property Office on the 20 of Aug. 2012 and there duly assigned Serial No. 10-2012-0090752.

### BACKGROUND OF THE INVENTION

1. Field of the Invention

The present invention relates to a pixel and an organic light emitting display using the same, and more particularly, to a pixel capable of increasing a contrast ratio and an organic light emitting display using the same.

2. Description of the Related Art

Recently, various flat panel displays (FPDs) capable of reducing weight and volume that are disadvantages of cathode ray tubes (CRTs) have been developed. The FPDs include liquid crystal displays (LCDs), field emission displays (FEDs), plasma display panels (PDPs), and organic light emitting displays.

Among the FPDs, the organic light emitting displays display images using organic light emitting diodes (OLEDs) that generate light by re-combination of electrons and holes. The organic light emitting display has high response speed and is driven with low power consumption.

The organic light emitting display includes a plurality of pixels arranged at intersections of a plurality of data lines, scan lines, and power supply lines in a matrix. Each of the pixels commonly includes an organic light emitting diode (OLED) and a driving transistor for controlling the amount of current that flows to the OLED. The pixels generate light components with predetermined brightness components while supplying currents from the driving transistors to the OLEDs corresponding to data signals.

On the other hand, the efficiency of the OLED is improved by various efforts. However, the OLED emits light in black brightness while the efficiency of the OLED increases. That is, although the driving transistor is turned off in the black brightness, the voltage of the anode electrode of the OLED is increased by the voltage applied to the drain electrode of the driving transistor so that the OLED emits light in the black brightness. When the OLED emits light in the black brightness, contrast ratio is reduced.

### SUMMARY OF THE INVENTION

Accordingly, the present invention has been developed to provide a pixel in which an organic light emitting diode (OLED) is set in a non-emission state in black brightness so that a contrast ratio is increased.

In order to achieve the foregoing and/or other aspects of the present invention, there is provided a pixel, including an organic light emitting diode (OLED), a first transistor for controlling an amount of current supplied from a first node coupled to a first electrode thereof to the OLED coupled to a second electrode thereof so as to correspond to a voltage applied to a second node, a second transistor coupled between the second electrode of the first transistor and the OLED and turned off when an emission control signal is supplied to an emission control line, and a capacitor coupled between the second electrode of the first transistor and the emission control line.

The pixel further includes a third transistor coupled between the first node and a first power supply and turned off when the emission control signal is supplied, and a storage capacitor coupled between the second node and the first power supply. The capacitor is set to have lower capacity than the storage capacitor. The pixel further includes a fourth transistor coupled between the first node and a data line and turned on when a scan signal is supplied to a current scan line, a fifth transistor coupled between the second electrode of the first transistor and the second node and turned on when the scan signal is supplied to the current scan line, and a sixth transistor coupled between the second node and an initial power supply and turned on when a scan signal is supplied to a previous scan line.

There is provided an organic light emitting display, including a scan driver for supplying scan signals to scan lines and for supplying emission control signals to emission control lines, a data driver for supplying data signals to data lines, and pixels positioned at intersections of the scan lines and the data lines. Each of the pixels positioned in an ith (i is a natural number) horizontal line includes an OLED, a first transistor for controlling an amount of current supplied from a first node, coupled to a first electrode thereof, to the OLED coupled to a second electrode thereof so as to correspond to a voltage applied to a second node, a second transistor coupled between the second electrode of the first transistor and the OLED and turned off when an emission control signal is supplied to an ith emission control line, and a capacitor coupled between the second electrode of the first transistor and the ith emission control line.

Each of the pixels includes a third transistor coupled between the first node and a first power supply and turned off when the emission control signal is supplied to the ith emission control line, and a storage capacitor coupled between the second node and the first power supply. The capacitor coupled between the second electrode of the first transistor and the ith emission control line is set to have lower capacity than the storage capacitor. Each of the pixels includes a fourth transistor coupled between the first node and a data line and turned on when a scan signal is supplied to a current scan line, a fifth transistor coupled between a second electrode of the first transistor and the second node and turned on when the scan signal is supplied to the current scan line, and a sixth transistor coupled between the second node and an initial power supply and turned on when a scan signal is supplied to a previous scan line. The current scan line is an ith scan line and the previous scan line is an (i−1)th scan line. The scan driver supplies an emission control signal to the ith emission control line so as to overlap the scan signals supplied to the current scan line and the previous scan line.

In the pixel according to the present invention and the organic light emitting display using the same, the voltage of the anode electrode of the OLED is reduced in the black brightness so that the OLED is set in the non-emission state. In this case, light is not generated by the pixel in the black brightness so that the contrast ratio may be increased.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a view illustrating an organic light emitting display according to an embodiment of the present invention;

FIG. 2 is a circuit diagram illustrating an embodiment of the pixel of FIG. 1;

FIG. 3 is a waveform chart illustrating a method of driving the pixel of FIG. 2; and

FIG. 4 is a view illustrating a simulation result of the pixel according to the embodiment of the present invention.

### DETAILED DESCRIPTION OF THE INVENTION

Hereinafter, certain exemplary embodiments according to the present invention will be described with reference to the accompanying drawings. Here, when a first element is described as being coupled to a second element, the first element may not only be directly coupled to the second element but may also be indirectly coupled to the second element via a third element. Furthermore, some of the elements that are not essential to a complete understanding of the invention are omitted for clarity. Also, like reference numerals refer to like elements throughout.

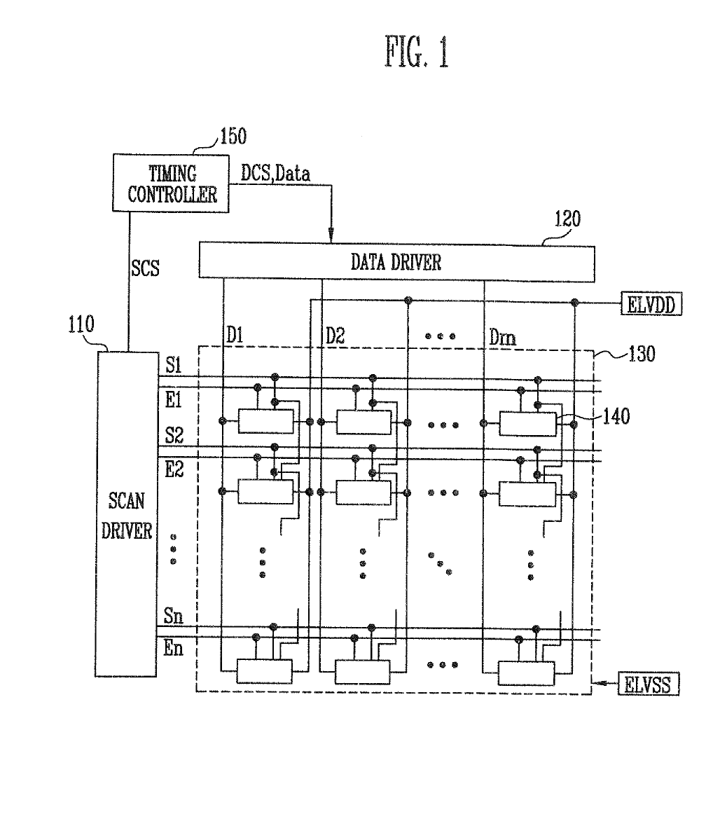

Hereinafter, a pixel and an organic light emitting display using the same will be described in detail as follows with reference to FIGS. 1 to 4 in which preferred embodiments by which those skilled in the art may easily perform the present invention are included.

FIG. 1 is a view illustrating an organic light emitting display according to an embodiment of the present invention.

Referring to FIG. 1, the organic light emitting display according to the embodiment of the present invention includes a pixel unit 130 including pixels 140 positioned at the intersections of scan lines S1 to Sn and data lines D1 to Dm, a scan driver 110 for driving the scan lines S1 to Sn and emission control lines E1 to En, a data driver 120 for driving the data lines D1 to Dm, and a timing controller 150 for controlling the scan driver 110 and the data driver 120.

The timing controller 150 generates a data driving control signal DCS and a scan driving control signal SCS in correspondence to synchronizing signals supplied from the outside. The data driving control signal DCS and the scan driving control signal SCS generated by the timing controller 150 are supplied to the data driver 120 and the scan driver 110, respectively. The timing controller 150 also supplies data Data supplied from the outside to the data driver 120.

The scan driver 110 receives the scan driving control signal SCS from the timing controller 150. The scan driver 110 that receives the scan driving control signal SCS generates scan signals and sequentially supplies the generated scan signals to the scan lines Si to Sn. In addition, the scan driver 110 generates emission control signals in response to the scan driving control signal SCS and sequentially supplies the generated emission control signals to the emission control lines E1 to En. Here, the width of the emission control signals is set to be equal to or larger than the width of the scan signals. For example, the emission control signal supplied to the ith (i is a natural number) emission control line Ei overlaps the scan signals supplied to the (i−1)th and ith scan lines Si−1 and Si.

On the other hand, the scan signals are set to have voltages at which the transistors included in the pixels 140 may be turned on, for example, low voltage. The emission control signals are set to have voltages at which the transistors included in the pixels 140 may be turned off, for example, high voltages.

The data driver 120 receives the data driving control signal DCS from the timing controller 150. The data driver 120 that receives the data driving control signal DCS generates data signals and supplies the generated data signals to the data lines D1 to Dm in synchronization with the scan signals.

The pixel unit 130 receives a first power supply ELVDD and a second power supply ELVSS from the outside so as to supply the first power supply ELVDD and the second power supply ELVSS to the pixels 140. The pixels 140 that receive the first power supply ELVDD and the second power supply ELVSS generate light components corresponding to the data signals, respectively.

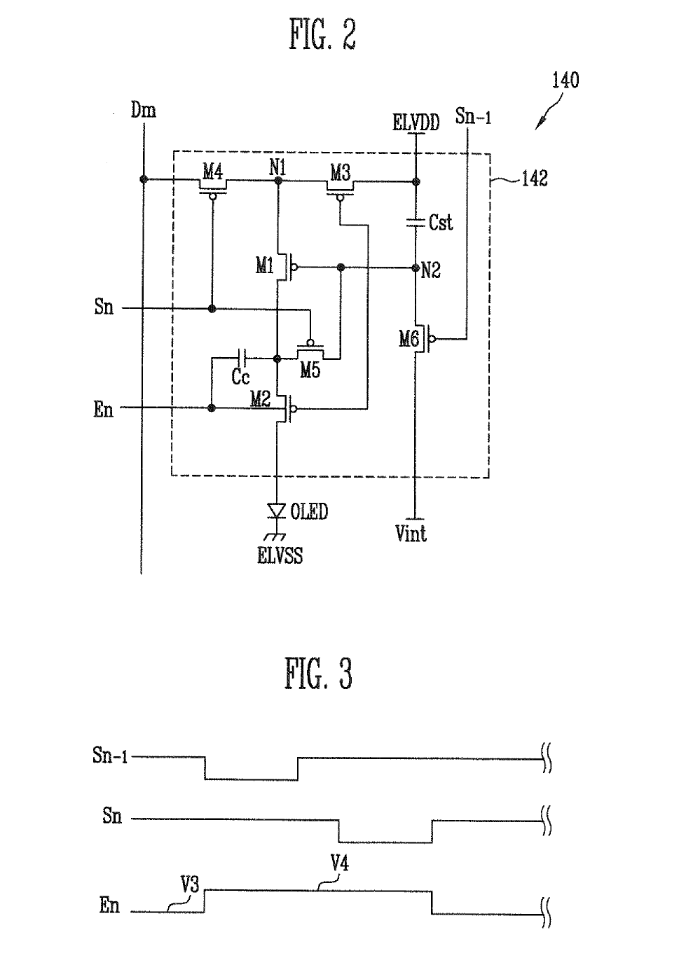

FIG. 2 is a circuit diagram illustrating an embodiment of the pixel of FIG. 1. In FIG. 2, for convenience sake, the pixel 140 coupled to the mth data line Dm, the nth scan line Sn, the (n−1)th scan line Sn−1, and the nth emission control line En will be illustrated.

Referring to FIG. 2, the pixel 140 according to the embodiment of the present invention includes an organic light emitting diode (OLED) and a pixel circuit 142 coupled to the data line Dm, the scan lines Sn−1 and Sn, and the emission control line En so as to control the amount of current supplied to the OLED.

The anode electrode of the OLED is coupled to the pixel circuit 142 and the cathode electrode of the OLED is coupled to the second power supply ELVSS. Here, the voltage value of the second power supply ELVSS is set to be lower than the voltage value of the first power supply ELVDD. The OLED generates light with predetermined brightness so as to correspond to the amount of current supplied from the pixel circuit 142.

The pixel circuit 142 controls the amount of current supplied to the OLED so as to correspond to the data signal supplied to the data line Dm when the scan signal is supplied to the scan line Sn. For this purpose, the pixel circuit 142 includes first to sixth transistors M1 to M6, a storage capacitor Cst, and a capacitor Cc.

The first electrode of the first transistor M1 is coupled to the first node N1 and the second electrode of the first transistor M1 is coupled to the first electrode of the second transistor M2. The gate electrode of the first transistor M1 is coupled to a second node N2. The first transistor M1 supplies a voltage applied to the second node N2, that is, current corresponding to the voltage charged in the storage capacitor Cst to the OLED.

The first electrode of the second transistor M2 is coupled to the second electrode of the first transistor M1 and the second electrode of the second transistor M2 is coupled to the anode electrode of the OLED. The gate electrode of the second transistor M2 is coupled to the emission control line En. The second transistor M2 is turned off when the emission control signal is supplied to the emission control line En and is turned on when the emission control signal is not supplied.

The first electrode of the third transistor M3 is coupled to the first power supply ELVDD and the second electrode of the third transistor M3 is coupled to the first node N1. The gate electrode of the third transistor M3 is coupled to the emission control line En. The third transistor M3 is turned off when the emission control signal is supplied to the emission control line En and is turned on when the emission control signal is not supplied.

The first electrode of the fourth transistor M4 is coupled to the data line Dm and the second electrode of the fourth transistor m4 is coupled to the first node N1. The gate electrode of the fourth transistor M4 is coupled to the nth scan line Sn. The fourth transistor M4 is turned on when the scan signal is supplied to the nth scan line Sn so as to supply the data signal from the data line Dm to the first node N1.

The first electrode of the fifth transistor M5 is coupled to the second electrode of the first transistor M1 and the second electrode of the fifth transistor M5 is coupled to the second node N2. The gate electrode of the fifth transistor M5 is coupled to the nth scan line Sn. The fifth transistor M5 is turned on when the scan signal is supplied to the nth scan line Sn so as to couple the first transistor M1 in the form of a diode.

The first electrode of the sixth transistor M6 is coupled to the second node N2 and the second electrode of the sixth transistor M6 is coupled to an initial power supply Vint. The gate electrode of the sixth transistor M6 is coupled to the (n−1)th scan line Sn−1. The sixth transistor M6 is turned on when the scan signal is supplied to the (n−1)th scan line Sn−1 so as to supply the voltage of the initial power supply Vint to the second node N2. Here, the initial power supply Vint is set to be a lower voltage than the data signal.

The storage capacitor Cst is coupled between the first power supply ELVDD and the second node N2. The storage capacitor Cst stores a voltage applied to the second node N2.

The capacitor Cc is coupled between the emission control line En and the second electrode of the first transistor M1. The capacitor Cc controls the voltage of the second electrode of the first transistor M1 so as to correspond to the voltage of the emission control line En. Actually, the capacitor Cc reduces the voltage of the second electrode of the first transistor M1 so as to prevent the OLED from emitting light in black brightness.

Here, the capacitor Cc as a coupling capacitor for controlling the voltage of the second electrode of the first transistor M1 to correspond to the voltage of the emission control line En is set to have a lower capacity than the storage capacitor Cst. Actually, the capacity of the capacitor Cc is experimentally determined so that the voltage of the second electrode of the first transistor M1 is controlled in consideration of the voltage and resolution of the emission control signal. For example, the capacitor Cc may be formed to have a capacity of no more than ⅕ of the capacity of the storage capacitor Cst.

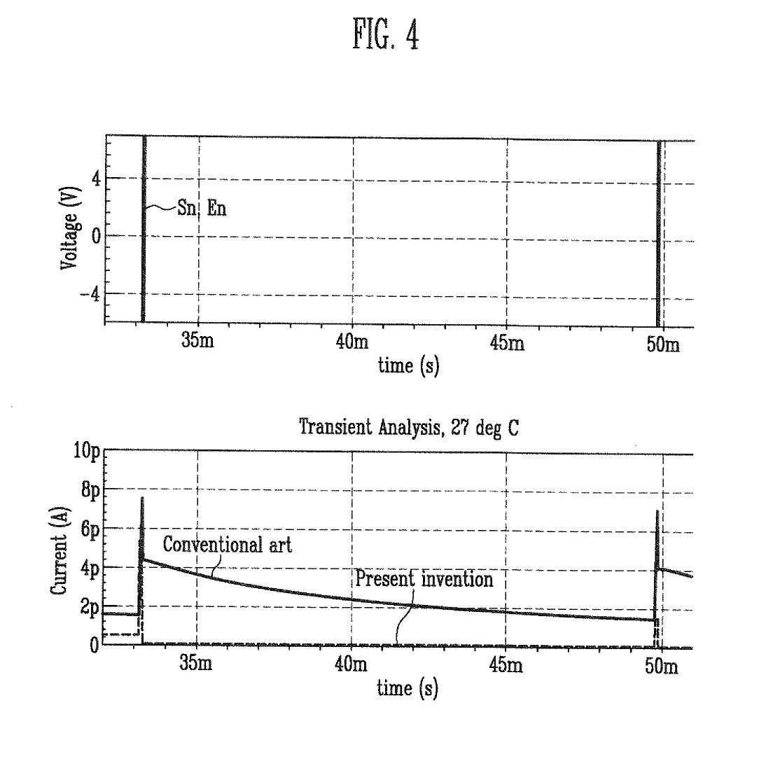

FIG. 3 is a waveform chart illustrating a method of driving the pixel of FIG. 2.

Referring to FIG. 3, first, the emission control signal is supplied to the emission control line En so that the second transistor M2 and the third transistor M3 are turned off. When the third transistor M3 is turned off, electrical coupling between the first power supply ELVDD and the first node N1 is blocked. When the second transistor M2 is turned off, electrical coupling between the first transistor M1 and the OLED is blocked. That is, in the period where the emission control signal is supplied, the pixel 140 is set in a non-emission state.

On the other hand, when the emission control signal is supplied to the emission control line En, the emission control line En is boosted from a third voltage V3 to a fourth voltage V4. In this case, the voltage of the second electrode of the first transistor M1 is increased by the capacitor Cc.

Then, the scan signal is supplied to the (n−1)th scan line Sn−1. When the scan signal is supplied to the (n−1)th scan line Sn−1, the sixth transistor M6 is turned on. When the sixth transistor M6 is turned on, the voltage of the initial power supply Vint is supplied to the second node N2. At this point, the storage capacitor Cst charges the voltage of the initial power supply Vint.

After the voltage of the initial power supply Vint is supplied to the second node N2, the scan signal is supplied to the nth scan line Sn. When the scan signal is supplied to the nth scan line Sn, the fourth transistor M4 and the fifth transistor M5 are turned on.

When the fifth transistor M5 is turned on, the second node N2 is electrically coupled to the second electrode of the first transistor M1. At this point, since the voltage of the initial power supply Vint is charged in the storage capacitor Cst having high capacity, the voltage of the second node N2 roughly maintains the voltage of the initial power supply Vint. In addition, according to the present invention, the voltage value of the initial power supply Vint may be set in a designing process so that the voltage of the second node N2 may be set as a lower voltage than the voltage of the data signal when the fifth transistor M5 is turned on.

When the fourth transistor M4 is turned on, the data signal from the data line Dm is supplied to the first node N1. At this point, since the second node N2 is roughly initialized to the voltage of the initial power supply Vint, the first transistor M1 is turned on. Then, a voltage obtained by subtracting the threshold voltage of the first transistor M1 from the voltage of the data signal applied to the first node N1 is applied to the second node N2 and the storage capacitor Cst stores the voltage applied to the second node N2.

After a predetermined voltage is charged in the storage capacitor Cst, supply of the emission control signal to the emission control line En is stopped so that the second transistor M2 and the third transistor M3 are turned on. Here, when the second transistor M2 and the third transistor M3 are turned on, a current path is formed from the first power supply ELVDD to the second power supply ELVSS via the OLED. At this point, the first transistor M1 controls the amount of current that flows from the first power supply ELVDD to the OLED to correspond to the voltage charged in the storage capacitor Cst.

On the other hand, when the supply of the emission control signal to the emission control line En is stopped, the voltage of the emission control line En is reduced from the fourth voltage V4 to the third voltage V3. In this case, the voltage of the second electrode of the first transistor M1 is reduced by the capacitor Cc.

When the black brightness is not realized, that is, when the first transistor M1 is turned on, a predetermined amount of current is supplied from the first transistor M1 to the OLED so as to correspond to the voltage applied to the second node N2. At this point, the OLED generates light with predetermined brightness so as to correspond to the amount of current supplied thereto. On the other hand, the capacitor Cc charges a predetermined voltage so as to correspond to the current supplied from the first transistor M1.

On the other hand, when the black brightness is realized, the first transistor M1 is turned off. Therefore, when the supply of the emission control signal to the emission control line En is stopped, the voltage of the anode electrode of the OLED is reduced by the voltage of the second electrode of the first transistor M1 reduced by the capacitor Cc. When the voltage of the anode electrode of the OLED is reduced, the OLED is turned off so that the black brightness may be stably realized.

FIG. 4 is a view illustrating a simulation result of the pixel according to the embodiment of the present invention. In FIG. 4, in the conventional art, the capacitor Cc is removed from the circuit of FIG. 2 and, according to the present invention, the capacitor Cc is added as illustrated in FIG. 2.

Referring to FIG. 4, when a data signal corresponding to black brightness is supplied, in a conventional pixel, predetermined current flows to the OLED by the high voltage of the anode electrode applied to the OLED. That is, in the conventional pixel, the OLED minutely emits light in the black brightness so that the contrast ratio is reduced.

On the other hand, in the pixel 140 according to the present invention, when the data signal corresponding to the black brightness is supplied, the voltage of the anode electrode of the OLED is reduced so that current does not flow to the OLED. That is, the pixel according to the present invention may maintain a non-emission state in the black brightness so that the contrast ratio may be increased.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A pixel, comprising:
an organic light emitting diode (OLED);
a first transistor for controlling an amount of current supplied from a first node coupled to a first electrode thereof to the OLED coupled to a second electrode thereof so as to correspond to a voltage applied to a second node;
a second transistor coupled between the second electrode of the first transistor and the OLED, and turned off when an emission control signal is supplied to an emission control line; and
a capacitor coupled between the second electrode of the first transistor and the emission control line.

2. The pixel as claimed in claim 1, further comprising:
a third transistor coupled between the first node and a first power supply and turned off when the emission control signal is supplied; and
a storage capacitor coupled between the second node and the first power supply.

3. The pixel as claimed in claim 2, the capacitor being set to have a lower capacity than the storage capacitor.

4. The pixel as claimed in claim 1, further comprising:
a fourth transistor coupled between the first node and a data line, and turned on when a scan signal is supplied to a current scan line;
a fifth transistor coupled between the second electrode of the first transistor and the second node, and turned on when the scan signal is supplied to the current scan line; and
a sixth transistor coupled between the second node and an initial power supply, and turned on when a scan signal is supplied to a previous scan line.

5. An organic light emitting display, comprising:
a scan driver for supplying scan signals to scan lines and for supplying emission control signals to emission control lines;
a data driver for supplying data signals to data lines; and
pixels positioned at intersections of the scan lines and the data lines;
each of the pixels positioned in an ith (i is a natural number) horizontal line comprising:
an OLED;
a first transistor for controlling an amount of current supplied from a first node coupled to a first electrode thereof to the OLED coupled to a second electrode thereof so as to correspond to a voltage applied to a second node;
a second transistor coupled between the second electrode of the first transistor and the OLED, and turned off when an emission control signal is supplied to an ith emission control line; and
a capacitor coupled between the second electrode of the first transistor and the ith emission control line.

6. The organic light emitting display as claimed in claim 5, each of the pixels comprising:
a third transistor coupled between the first node and a first power supply and turned off when the emission control signal is supplied to the ith emission control line; and
a storage capacitor coupled between the second node and the first power supply.

7. The organic light emitting display as claimed in claim 6, the capacitor being set to have a lower capacity than the storage capacitor.

8. The organic light emitting display as claimed in claim 5, each of the pixels comprising:
a fourth transistor coupled between the first node and a data line, and turned on when a scan signal is supplied to a current scan line;
a fifth transistor coupled between a second electrode of the first transistor and the second node, and turned on when the scan signal is supplied to the current scan line; and
a sixth transistor coupled between the second node and an initial power supply and turned on when a scan signal is supplied to a previous scan line.

9. The organic light emitting display as claimed in claim 8, the current scan line being an ith scan line and the previous scan line being an (i−1)th scan line.

10. The organic light emitting display as claimed in claim 8, the scan driver supplying an emission control signal to the ith emission control line so as to overlap the scan signals supplied to the current scan line and the previous scan line.
